(19) United States
(12) Patent Application Publication
(10) Pub. No.: US 2021/0214172 A1
(43) Pub. Date: Jul. 15, 2021

(54) Bark Blower

(71) Applicant: David Kisenwether, Sugarloaf, PA (US)

(72) Inventor: David Kisenwether, Sugarloaf, PA (US)

(21) Appl. No.: 16/736,867

(22) Filed: Jan. 8, 2020

(51) Int. Cl. B65G 53/04; F04D 27/00; F04D 17/08

(52) U.S. Cl. CPC B65G 53/04; F04D 17/08; F04D 27/004

(57) ABSTRACT

A reduced size bark blower that incorporates the innovative concept of a centrifugal fan instead of an air lock thereby reducing the overall weight of the machine.

### CROSS REFERENCE TO RELATED APPLICATIONS

This Non-Provisional patent application claims priority to U.S. Provisional Patent Application 62/799,234, dated Jan. 31, 2019, entitled Bark Blower.

### Federal Research Statement

None

### BACKGROUND OF THE INVENTION

The present invention relates to a revolutionary device that distributes ground wood bark using a centrifugal blower. More specifically, this invention is a modular device that can be easily loaded onto any standard dump truck tail gate or can stand by itself. The instant invention also includes a slotted base that allows a loader bucket to pick the device up and move it.

Bark blowers are significantly different from vegetation mulching machines. Mulching devices are designed to cut and rend large amounts of vegetation (such as hay bales) and distribute them. Such mulching devices are typically used to produce cover for seeding operations. Bark blowers are designed to distribute already ground wood bark. Frequently, the bark blowers are used to distribute ground bark into erosion control tubes used in construction projects.

The current generation of bark blowers uses an air lock and a positive displacement blower. Air locks are precision machined mechanisms and when used to convey wood bark require significant maintenance and replacement. The instant invention circumvents the air lock issue by eliminating airlocks and positive displacement blowers and replacing them with a centrifugal blower. Elimination of the air lock results in a smaller, lighter, more efficient unit that significantly lowers the initial cost of the device in addition to the overall life cycle cost of the device.

### SUMMARY OF THE INVENTION

The present invention relates to a revolutionary device that distributes ground wood bark or other solids by using a centrifugal blower or fan and exhausts the ground material through a flexible hose. This innovative device eliminates the need for an air lock and a positive displacement blower. More specifically, this invention is a modular device that can be easily loaded onto any standard dump truck tail gate or can stand by itself. The present invention also includes a slotted base that allows a loader bucket to pick the device up and move it. This instant apparatus comprises nine major components: (1) the centrifugal blower, (2) side hooks, (3) the hopper, (4) the controls, (5) the engine, (6) one or more fuel tanks, (7) a slotted base, (8) hydraulic components, and (9) an agitating plate that forms one side of the hopper.

### BRIEF DESCRIPTION OF DRAWINGS

FIG. 1 shows a rear view of the bark blower 10. This view shows the hooks 310 that are attached to the body of the bark blower. These hooks 310 are designed such that they can hold the bark blower to the tail gate of any standard dump truck. Also shown is the slotted base 340 on either side of the bark blower that allows the device to be picked up on either side by a loader bucket and moved.

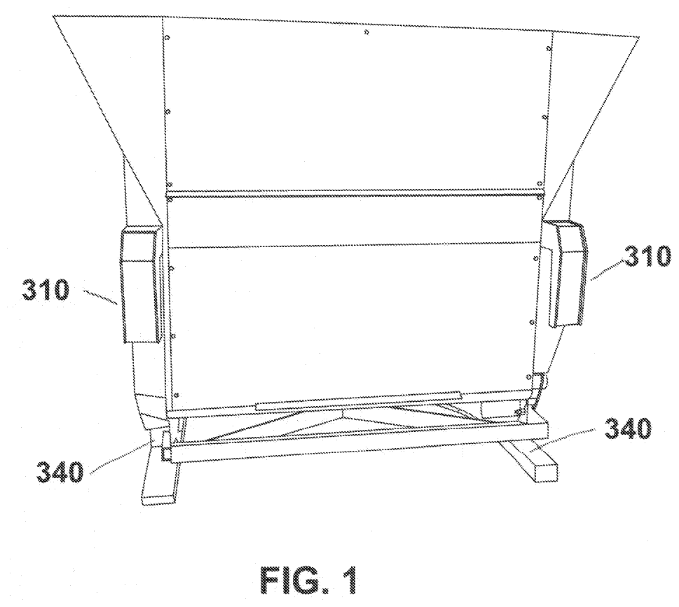

FIG. 2 is a perspective view of the bark blower 10 and in particular shows the oscillating hopper side drive chain 410 and the augur chain drive 420. The hooks 310 that attach the device to the tail gate of any standard dump truck are also shown.

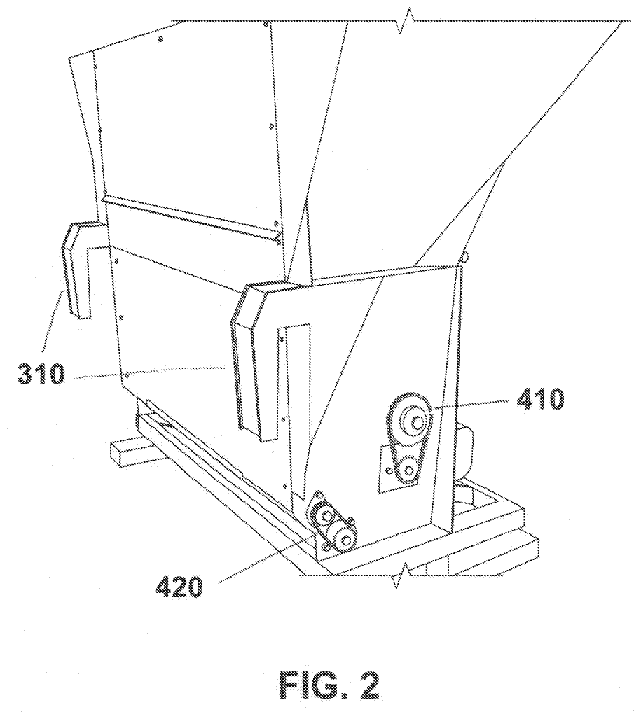

FIG. 3 shows an angled perspective view of the bark blower 10 and in particular shows the oscillating hopper side drive chain 410 and the augur chain drive 420. This view shows that the slotted base 340 is configured so that the bark blower can be lifted from either side by a loader bucket. In addition, this view shows one of the hooks 310 that allow the bark blower to be attached to the tail gate of any standard dump truck. The discharge chute 130 and hopper 330 are also shown.

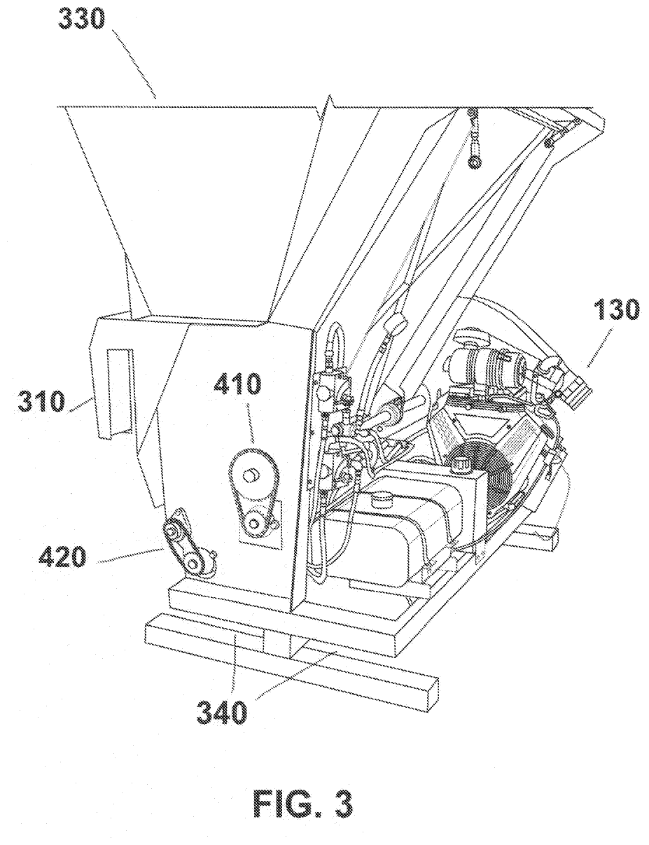

FIG. 4 shows the front view of the bark blower 10 and in particular shows the oscillating front side 335 of the hopper 330. The front side 335 oscillates in order to prevent bark or other similar material from jamming the device.

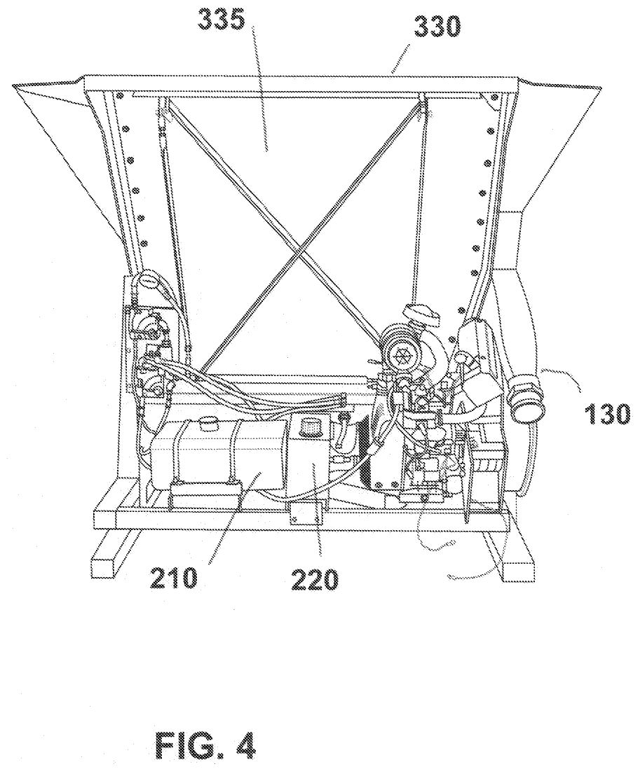

FIG. 5 shows a perspective view of the bark blower 10 showing the fuel tank 210, hydraulic tank 220, the engine 225 and the discharge chute 130.

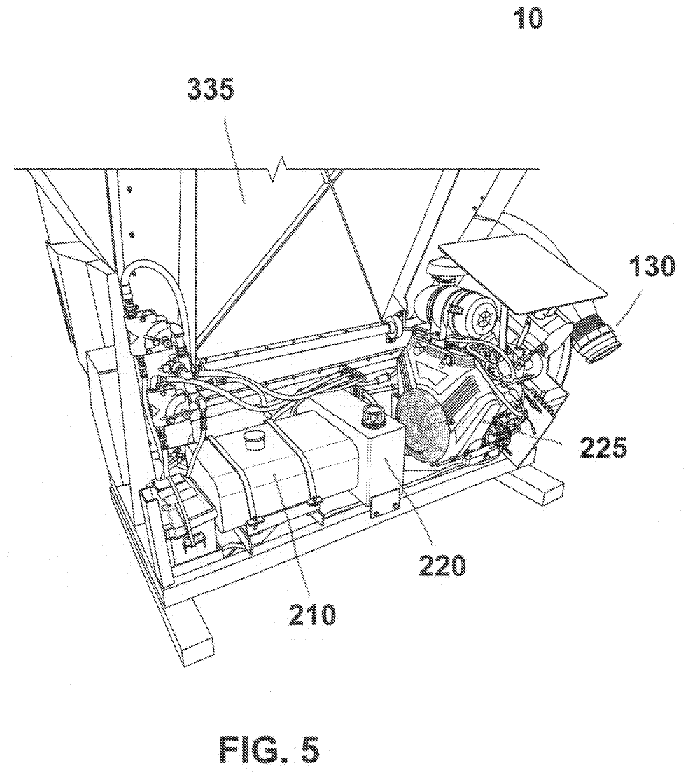

FIG. 6 shows a closer perspective view of the bark blower 10 showing the fuel tank 210, hydraulic tank 220, engine 225, discharge chute 130, centrifugal fan housing 100, centrifugal fan housing cover 120, and assorted ventilation holes 110 in the housing cover 120.

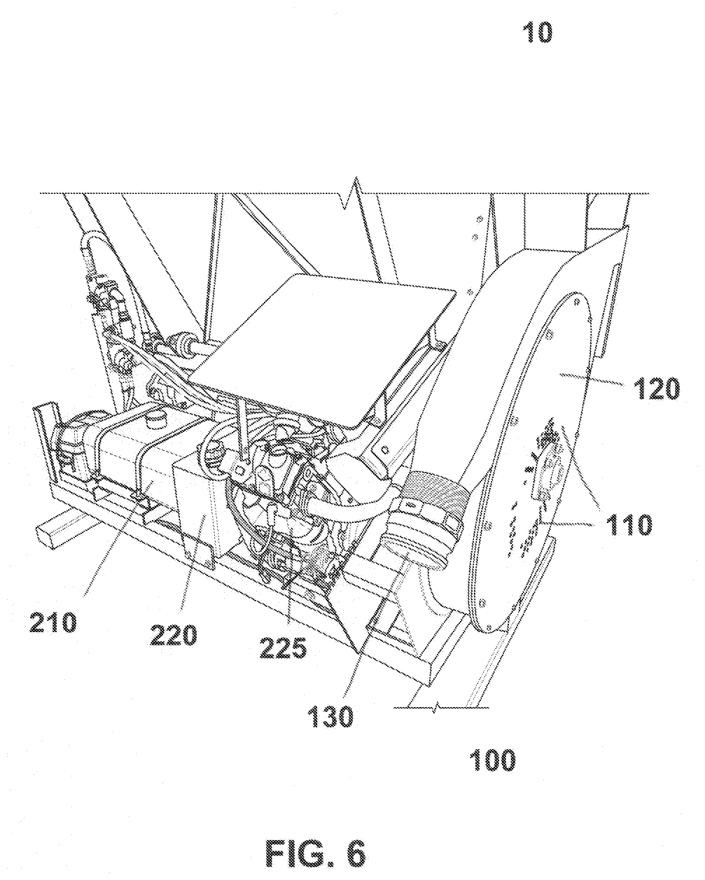

### DETAILED DESCRIPTION OF THE INVENTION

The present invention is directed toward a reduced size bark blower 10 that utilizes a specially designed centrifugal blower as the impetus for distributing bark and/or other similar solids. The current generation of bark blowers uses air locks and a positive displacement blower, which are expensive, require frequent maintenance, must be replaced frequently, and add considerably to the size and weight of the bark blower. The smaller size of the instant invention allows it to be moved easily with just about any type of loader. In addition, the smaller size of the instant invention allows it to be placed on the tail gate of just about any dump truck to result in a mobile bark blower. The present invention nominally weighs about 1,400 lbs. Other commercially available bark blowers with air locks and positive displacement blowers generally weigh in excel of 4,000 lbs.

The major components of the instant invention comprise: (1) the centrifugal blower, (2) side hooks, (3) the hopper, (4) the controls, (5) the engine, (6) one or more fuel tanks, (7) a slotted base, (8) hydraulic components, and (9) an agitating plate that forms one side of the hopper.

The best mode for practicing the instant invention is as follows: The device can be moved into position by attaching by the side hooks 310 to the tail gate of any standard sized dump truck or similar vehicle and placing it where it is optimally used. Alternatively, the device can be moved by sliding a loader bucket slightly above either side of the slotted base 340 and lifting and moving the device to where it can be optimally used. The significantly reduced weight of this invention allows smaller vehicles (dump trucks or front/rear loaders) to move the device. Other bark blowers require larger vehicles to tow or transport the bark blower by flat bed, thereby leading to increased overall operating costs.

Erosion control tubes are inserted over the flexible hose that is attached to the discharge chute 130. The device is started and ground bark or other similar material is loaded into the hopper by a loader or shovel or other similar means. The agitating plate of one side of the hopper is engaged to prevent material from jamming. An auger or similar device is used to inject the ground bark or similar material into the housing where the centrifugal fan is located. The fan can be run at variable speeds to compensate for varying compositions and moisture content of the ground bark. Material is continuously fed into the hopper by loader/shovel until the tube is full and the engine is secured.

1. A light weight mechanical device for transporting ground wood bark or similar material:
a. a variable speed centrifugal blower,
b. a hopper,
c. controls,
d. an engine,
e. one or more fuel tanks, and
f. hydraulic components.

2. A device as in claim 1 further comprising a mechanical means such as hooks affixed to the exterior that allow the device to be lifted and transported by a truck.

3. A device as in claim 1 further comprising a slotted base that allows the device to be lifted and moved by a front loader.

4. A device as in claim 1 wherein an auger is used to inject the wood bark or other material into the centrifugal fan.

5. A device as in claim 1 wherein the total weight of the device is less than 1,500 pounds.

6. A device as in claim 1 further comprising an agitating plate that forms one side of the hopper.

7. A device as in claim 1 wherein the ground bark is discharged into an erosion control tube.

8. A device as in claim 1 which does not comprise an air lock or similar device.

9. A bark blower comprising:
a. a variable speed centrifugal blower,
b. a hopper,
c. controls,
d. an engine,
e. one or more fuel tanks,
f. a slotted base, and
g. hydraulic components.

10. A device as in claim 9 further comprising hooks affixed to the exterior that allow the device to be lifted and transported by a truck.

11. A device as in claim 9 further comprising a slotted base that allows the device to be lifted and moved by a front loader.

12. A device as in claim 9 wherein an auger is used to inject the wood bark or other material into the centrifugal fan.

13. A device as in claim 9 wherein the total weight of the device is less than 1,500 pounds.

14. A device as in claim 9 further comprising an agitating plate that forms one side of the hopper.

15. A device as in claim 9 wherein the ground bark is discharged into a flexible hose and then into an erosion control tube.

16. A device as in claim 9 which does not comprise an air lock or similar device.

17. A method for using a bark blower comprising the following steps:
a. Moving the bark blower to the job site by the use of a front loader engaged with the slotted base of the bark blower or by attaching the bark blower to a dump truck tailgate be means of the hooks,
b. Loading ground bark or similar material into the hopper of the bark blower,
c. Engaging the engine to start a centrifugal fan,
d. Activating the agitating plate to ensure the bark does not jam in the hopper,
e. Engaging an auger to inject the ground bark from the hopper into the centrifugal fan,
f. Conveying the ground bark into the discharge tube by means of the centrifugal fan, and
g. Connecting the discharge of the centrifugal fan to an erosion control sleeve.

18. The method of claim 17 wherein a flexible tube is inserted between the discharge chute and the erosion control tube.

19. The method of claim 18 where ground bark is continuously fed into the hopper.

20. The method of claim 17 where the centrifugal fan can run at various speeds.
